(19) United States
(12) Patent Application Publication
(10) Pub. No.: US 2026/0140738 A1
(43) Pub. Date: May 21, 2026

(54) PROCESSING CIRCUITRY AND INFORMATION PROCESSING DEVICE

(71) Applicant: Mitsubishi Electric Corporation, Tokyo (JP)

(72) Inventor: Shoei NASHIMOTO, Tokyo (JP)

(73) Assignee: Mitsubishi Electric Corporation, Tokyo (JP)

(21) Appl. No.: 19/446,080

(22) Filed: Jan. 12, 2026

Related U.S. Application Data
(63) Continuation of application No. PCT/JP2023/032790, filed on Sep. 8, 2023.

(51) Int. Cl. G06F 9/30; G06F 9/38

(52) U.S. Cl. CPC G06F 9/30021; G06F 9/3808

(57) ABSTRACT

A fetch circuit (110) fetches, for each cycle time, an instruction of the cycle time as a reference instruction, and also fetches an instruction of a cycle time that is earlier than the cycle time by a shift time of one or more cycles as a comparison instruction. A comparison circuit (120) compares, for each cycle time, a comparison instruction that is fetched with a reference instruction fetched at a cycle time that is earlier than a cycle time at which the comparison instruction is fetched by the shift time. When the compared reference instruction matches the compared comparison instruction, an operation circuit (140) executes the compared reference instruction, for each cycle time.

### CROSS REFERENCE TO RELATED APPLICATION

This application is a Continuation of PCT International Application No. PCT/JP2023/032790, filed on September 8, 2023, which is hereby expressly incorporated by reference into the present application.

### TECHNICAL FIELD

The present disclosure relates to a processor with fault tolerance.

### BACKGROUND ART

Security bypass attacks using fault attacks have become a problem.

The assumption that a program operates as written falls apart due to the following mechanisms.

Mechanism 1: An instruction skip occurs due to a setup time violation caused by a power or clock glitch.

Mechanism 2: Data corruption (bit flipping) occurs due to a photocurrent or an eddy current.

If a fault attack is launched against a typical processor with a five-stage pipeline, an error such as a memory access error is likely to occur on the longest path where processing requires time (critical path). In particular, an instruction fetch (IF) or a memory access (MEM) is prone to corruption.

The simplest fault mechanism is an instruction skip associated with a fetch error.

Patent Literature 1 discloses a data processing device as described below.

The data processing device includes a first processing device, a second processing device, and a comparison device.

The first processing device processes input data in a first processing period to generate first output data.

The second processing device processes the input data in a second processing period to generate second output data.

The comparison device compares the first output data with the second output data to determine whether or not there is a processing error.

### CITATION LIST

### Patent Literature

Patent Literature 1: JP 4386766 B

### SUMMARY OF INVENTION

### Technical Problem

The data processing device of Patent Literature 1 realizes redundant processing by shifting processing periods, and cannot notice an instruction skip (NOP) associated with a fetch error before processing.

An object of the present disclosure is to make it possible to notice an instruction skip associated with a fetch error.

### Solution to Problem

Processing circuitry of the present disclosure includes

a fetch circuit to fetch, for each cycle time, an instruction of the cycle time as a reference instruction, and also fetch an instruction of a cycle time that is earlier than the cycle time by a shift time of one or more cycles as a comparison instruction;

a comparison circuit to compare, for each cycle time, a comparison instruction

that is fetched with a reference instruction fetched at a cycle time that is earlier than a cycle time at which the comparison instruction is fetched by the shift time; and

an operation circuit to, when the compared reference instruction matches the compared comparison instruction, execute the compared reference instruction, for each cycle time.

### Advantageous Effects of Invention

According to the present disclosure, it is possible to notice an instruction skip associated with a fetch error.

### BRIEF DESCRIPTION OF DRAWINGS

FIG. 1 is a configuration diagram of processing circuitry 100 in Embodiment 1.

FIG. 2 is a configuration diagram of a fetch circuit 110 in Embodiment 1.

FIG. 3 is a diagram illustrating an example of the configuration of the processing circuitry 100 in Embodiment 1.

FIG. 4 is a diagram illustrating an example of a timing chart in Embodiment 1.

FIG. 5 is a configuration diagram of a conventional processor.

FIG. 6 is a diagram illustrating differences in operation between the processing circuitry 100 in Embodiment 1 and the conventional processor.

FIG. 7 is a diagram illustrating an implementation example of the processing circuitry 100 in Embodiment 1.

FIG. 8 is a diagram illustrating an implementation example of the processing circuitry 100 in Embodiment 1.

FIG. 9 is a diagram illustrating an implementation example of the processing circuitry 100 in Embodiment 1.

FIG. 10 is a configuration diagram of an information processing device 200 in Embodiment 1.

### DESCRIPTION OF EMBODIMENTS

In the embodiment and drawings, the same elements or corresponding elements are denoted by the same reference sign. Description of an element denoted by the same reference sign as that of an element that has been described will be suitably omitted or simplified. Arrows in diagrams mainly indicate flows of signals, data, or processing.

### Embodiment 1.

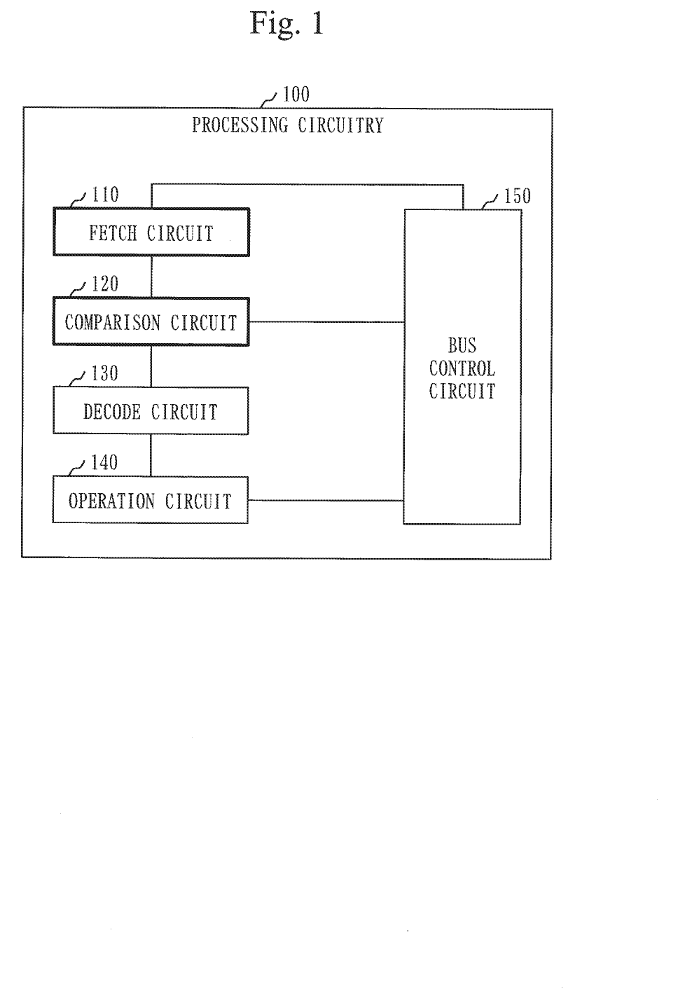

Processing circuitry 100 will be described based on FIGS. 1 to 10.

### Description of Configuration

Based on FIG. 1, a configuration of the processing circuitry 100 will be described.

The processing circuitry 100 is hardware that realizes execution of any processing.

Examples of the processing circuitry 100 are a processor and an FPGA. Examples of a processor are a CPU and a GPU. CPU is an abbreviation for central processing unit. GPU is an abbreviation for graphics processing unit. FPGA is an abbreviation for field programmable gate array.

The processing circuitry 100 includes a fetch circuit 110, a comparison circuit 120, a decode circuit 130, an operation circuit 140, and a bus control circuit 150.

The processing circuitry 100 is characterized by the fetch circuit 110 and the comparison circuit 120.

The fetch circuit 110 is a circuit that fetches, for each cycle time, an instruction of the cycle time as a reference instruction, and also fetches an instruction of a cycle time that is earlier than the cycle time by a shift time of one or more cycles as a comparison instruction.

A cycle time is equivalent to a time when a clock signal is generated.

A shift time is a time period equivalent to a predetermined number of cycles.

An instruction of a cycle time is an instruction stored in a memory area identified by a program counter value (address) at the cycle time.

The comparison circuit 120 is a circuit that compares, for each cycle time, a comparison instruction that is fetched with a reference instruction fetched at a cycle time that is earlier than a cycle time at which the comparison instruction is fetched by the shift time.

If the compared reference instruction does not match the compared comparison instruction, the comparison circuit 120 outputs an alert signal.

The decode circuit 130 is a circuit that decodes the compared reference instruction if the compared reference instruction matches the compared comparison instruction.

The operation circuit 140 is a circuit that executes the compared reference instruction (decoded reference instruction) if the compared reference instruction matches the compared comparison instruction, for each cycle time.

The bus control circuit 150 is a circuit that controls a bus of the processing circuitry 100.

In Embodiment 1, the processing circuitry 100 functions as described below.

The fetch circuit 110 fetches, for each cycle time, two or more comparison instructions corresponding to two or more mutually different shift times.

The comparison circuit 120 compares, for each cycle time, two or more comparison instructions that are fetched with a reference instruction fetched at a cycle time that is earlier than each individual cycle time by the shift time corresponding to an individual comparison instruction of the two or more comparison instructions, where the individual cycle time is a cycle time at which the individual comparison instruction is fetched.

If the compared reference instruction matches the two or more compared comparison instructions, the decode circuit 130 decodes the compared reference instruction, for each cycle time.

If the compared reference instruction matches the two or more compared comparison instructions, the operation circuit 140 executes the compared reference instruction (decoded reference instruction), for each cycle time.

If the compared reference instruction does not match at least one of the two or more compared comparison instructions, the comparison circuit 120 selects an instruction to be executed, based on majority vote among the compared reference instruction and the two or more compared comparison instructions, for each cycle time.

If the compared reference instruction does not match at least one of the two or more compared comparison instructions, the decode circuit 130 decodes the instruction selected based on majority vote, for each cycle time.

If the compared reference instruction does not match at least one of the two or more compared comparison instructions, the operation circuit 140 executes the instruction selected based on majority vote (decoded instruction), for each cycle time.

If the compared reference instruction does not match at least one of the two or more compared comparison instructions, the comparison circuit 120 outputs an alert signal, for each cycle time. The output alert signal is input to the bus control circuit 150.

When the alert signal is input, the bus control circuit 150 performs bus control for exception handling. For example, the bus control circuit 150 sets a program counter value for exception handling to a program counter.

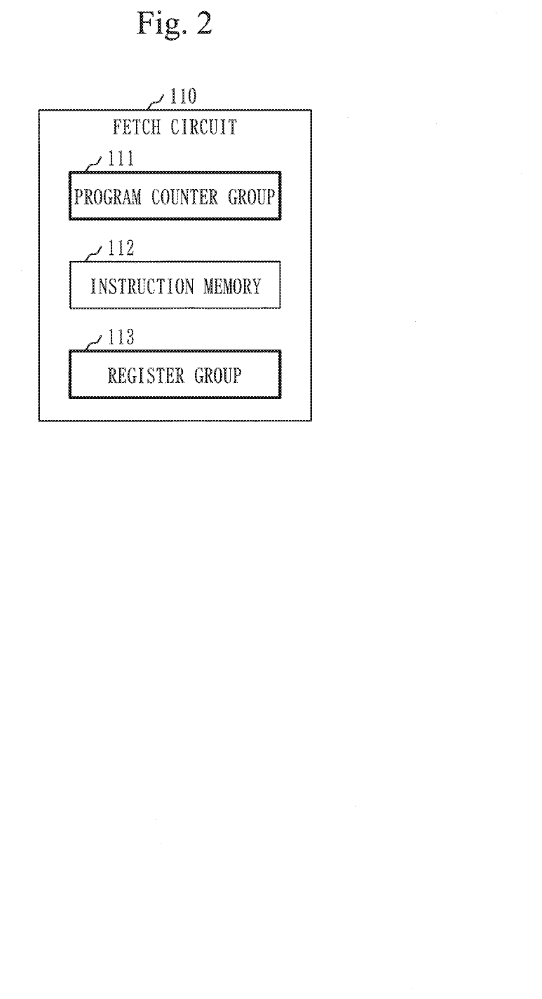

Based on FIG. 2, a configuration of the fetch circuit 110 will be described.

The fetch circuit 110 includes a program counter group 111, an instruction memory 112, and a register group 113.

The fetch circuit 110 is characterized by the program counter group 111 and the register group 113.

The program counter group 111 is composed of two or more program counters. Each program counter stores, for each cycle time, a program counter value corresponding to the cycle time.

One program counter in the program counter group 111 is referred to as a main program counter.

The main program counter stores, for each cycle time, a program counter value at the cycle time. The program counter value stored in the main program counter is referred to as a main program counter value.

An instruction stored in a memory area identified by the main program counter value is set as a reference instruction.

Each program counter other than the main program counter is referred to as a sub program counter.

The sub program counter stores, for each cycle time, a main program counter value at a cycle time that is the shift time before the cycle time. A program counter value stored in the sub program counter is referred to as a sub program counter value.

An instruction stored in a memory area identified by the sub program counter value is set as a comparison instruction.

The instruction memory 112 is a memory in which two or more instructions are stored sequentially.

The register group 113 is composed of a plurality of registers. Each register stores one instruction for each cycle time.

The register group 113 includes one or more registers for each program counter.

One or more registers for the main program counter store one or more reference instructions corresponding to one or more cycle times.

One or more registers for the sub program counter store one or more comparison instructions corresponding to one or more cycle times.

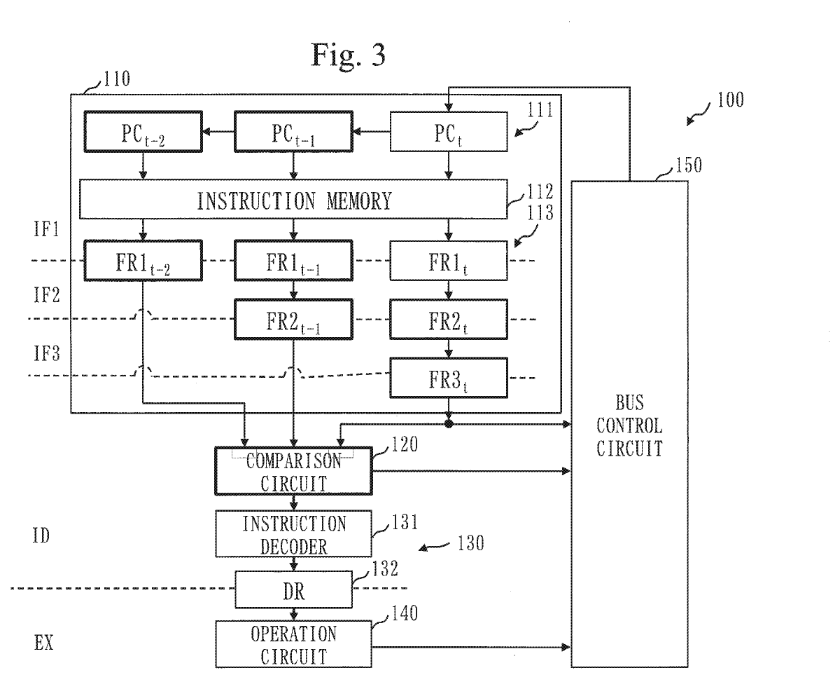

FIG. 3 illustrates an example of the configuration of the fetch circuit 110.

The program counter group 111 is composed of three program counters (PCs).

The register group 113 is composed of six registers (FRs).

The register group 113 includes three registers (FR1ₜ to FR3ₜ) corresponding to a program counter PCₜ.

The register group 113 includes two registers (FR1ₜ₋₁, FR2ₜ₋₁) corresponding to a program counter PCₜ₋₁.

The register group 113 includes one register (FR1ₜ₋₂) corresponding to a program counter PCₜ₋₂.

The decode circuit 130 includes an instruction decoder 131 and a register 132 (DR).

In FIG. 3, “IF” stands for Instruction Fetch.

“ID” stands for Instruction Decode.

“EX” stands for Execution.

### Description of Operation

A procedure for the operation of the processing circuitry 100 is equivalent to a fault tolerance processing method.

Based on FIG. 3, the fault tolerance processing method will be described.

The program counter PCₜ is set as the main program counter, and the program counters (PCₜ₋₁, PCₜ₋₂) are set as the sub program counters.

The shift time for the program counter PCₜ₋₁ is set as a time period equivalent to one cycle.

The shift time for the program counter PCₜ₋₂ is set as a time period equivalent to two cycles.

At each cycle time t, the processing circuitry 100 operates as described below.

The program counter PCₜ₋₂ stores a program counter value Vₜ₋₂ stored in the program counter PCₜ₋₁. The program counter value Vₜ₋₂ is a program counter value of the program counter PCₜ of two cycles ago.

The register FR1ₜ₋₂ stores an instruction located in a memory area identified by the program counter value Vₜ₋₂. The instruction stored in the register FR1ₜ₋₂ is referred to as a comparison instruction I1ₜ₋₂.

The comparison instruction I1ₜ₋₂ is an instruction fetched to the register FR1ₜ₋₂ at the cycle time t.

The register FR2ₜ₋₁ stores an instruction stored in the register FR1ₜ₋₁. The instruction stored in the register FR2ₜ₋₁ is referred to as a comparison instruction I2ₜ₋₁.

The comparison instruction I2ₜ₋₁ is an instruction fetched to the register FR1ₜ₋₁ one cycle before the cycle time t.

The program counter PCₜ₋₁ stores a program counter value Vₜ₋₁ stored in the program counter PCₜ. The program counter value Vₜ₋₁ is a program counter value of the program counter PCₜ of one cycle ago.

Th register FR1ₜ₋₁ stores an instruction located in a memory area identified by the program counter value Vₜ₋₁.

The register FR3ₜ stores an instruction stored in the register FR2ₜ. The instruction stored in the register FR3ₜ is referred to as a reference instruction I3ₜ.

The reference instruction I3ₜ is an instruction fetched to the register FR1ₜ two cycles before the cycle time t.

The register FR2ₜ stores an instruction stored in the register FR1ₜ.

The bus control circuit 150 sets a program counter value Vₜ at the cycle time t in the program counter PCₜ.

The program counter PCₜ stores the program counter value Vₜ.

The register FR1ₜ stores an instruction located in a memory area identified by the program counter value Vₜ.

The comparison circuit 120 compares the reference instruction I3ₜ stored in the register FR3ₜ with the comparison instruction I2ₜ₋₁ stored in the register FR2ₜ₋₁ and the comparison instruction I1ₜ₋₂ stored in the register FR1ₜ₋₂.

If the reference instruction I3ₜ, the comparison instruction I2ₜ₋₁, and the comparison instruction I1ₜ₋₂all match, the processing circuitry 100 operates as described below.

The comparison circuit 120 outputs the reference instruction I3ₜ. The reference instruction I3ₜ output from the comparison circuit 120 is input to the instruction decoder 131.

The instruction decoder 131 decodes the reference instruction I3ₜ.

The register 132 stores the decoded reference instruction I3ₜ.

The operation circuit 140 executes the reference instruction I3ₜ stored in the register 132, and outputs an operation result.

The operation result is input to the bus control circuit 150, for example.

If only two instructions of the reference instruction I3ₜ, the comparison instruction I2t₋₁, and the comparison instruction I1ₜ₋₂ match, the processing circuitry 100 operates as described below.

The comparison circuit 120 selects an instruction based on majority vote among the reference instruction I3ₜ, the comparison instruction I2ₜ₋₁, and the comparison instruction I1ₜ₋₂, and outputs the instruction that has been selected. The output instruction is referred to as a selected instruction.

The instruction decoder 131 decodes the selected instruction.

The register 132 stores the decoded selected instruction.

The operation circuit 140 executes the selected instruction stored in the register 132, and outputs an operation result.

In addition, the comparison circuit 120 outputs an alert signal. The output alert signal is input to the bus control circuit 150. The bus control circuit 150 performs bus control for exception handling.

If the reference instruction I3ₜ, the comparison instruction I2ₜ₋₁, and the comparison instruction I1ₜ₋₂ do not match at all, the processing circuitry 100 operates as described below.

The comparison circuit 120 outputs an alert signal. The output alert signal is input to the bus control circuit 150. The bus control circuit 150 performs bus control for exception handling.

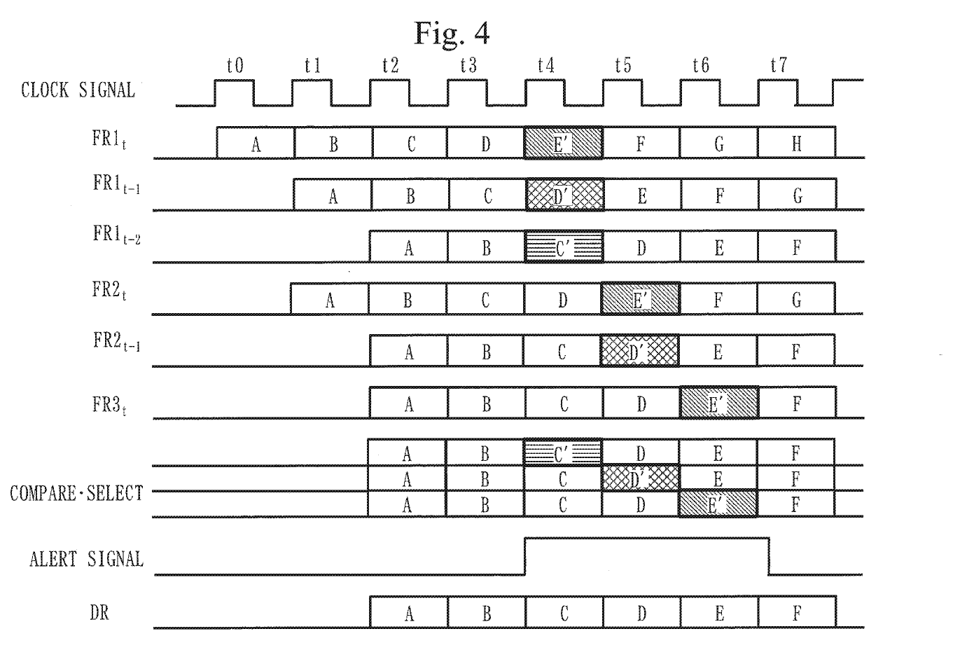

Based on FIG. 4, a specific example of the operation of the processing circuitry 100 will be described.

At cycle time t2, the register FR1ₜ₋₂ stores an instruction A, the register FR2ₜ₋₁ stores the instruction A, and the register FR3ₜ stores the instruction A.

That is, every instruction in the register FR1ₜ₋₂, the register FR2ₜ₋₁, and the register FR3ₜ is the instruction A, which is a match.

In this case, the instruction A is decoded, stored in the register DR, and executed.

It is assumed that an error occurs in a fetch at cycle time t4 due to a fault attack, and three instructions stored in three registers (FR1ₜ, FR1ₜ₋₁, FR1ₜ₋₂) at the first stage are corrupted.

At cycle time t4, the register FR1ₜ₋₂ stores an instruction C', the register FR2ₜ₋₁ stores an instruction C, and the register FR3ₜ stores the instruction C.

That is, the instruction C' in the register FR1ₜ₋₂ does not match the instruction C in the register FR2ₜ₋₁ and the register FR3ₜ.

In this case, the instruction C is selected based on majority vote, decoded, stored in the register DR, and executed. In addition, an alert signal is output.

At cycle time t5, the register FR1ₜ₋₂ stores an instruction D, the register FR2ₜ₋₁ stores an instruction D', and the register FR3ₜ stores the instruction D.

That is, the instruction D' in the register FR2ₜ₋₁ does not match the instruction D in the register FR1ₜ₋₂ and the register FR3ₜ.

In this case, the instruction D is selected based on majority vote, decoded, stored in the register DR, and executed. In addition, an alert signal is output.

At cycle time t6, the register FR1ₜ₋₂ stores an instruction E, the register FR2ₜ₋₁ stores the instruction E, and the register FR3ₜ stores an instruction E'.

That is, the instruction E' in the register FR3ₜ does not match the instruction E in the register FR1ₜ₋₂ and the register FR2ₜ₋₁.

In this case, the instruction E is selected based on majority vote, decoded, stored in the register DR, and executed. In addition, an alert signal is output.

### *** Comparison with Conventional Technology ***

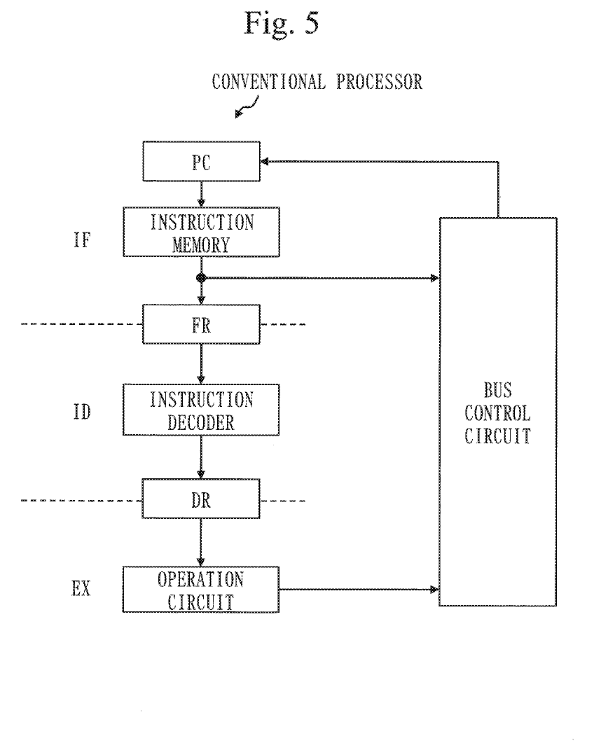

FIG. 5 illustrates a configuration of a conventional processor.

In the conventional processor, a fetch circuit (IF) includes one program counter

PC and one register FR.

On the other hand, the processing circuitry 100 is configured as described below (refer to FIG. 3).

The fetch circuit 110 includes two or more program counter PCs and a plurality of register FRs.

The fetch circuit 110 includes two or more channels of fetch units. In FIG. 3, a fetch unit of a first channel is composed of the program counter PCₜ, the instruction memory 112, and three registers (FR1ₜ, FR2ₜ, FR3ₜ). A fetch unit of a second channel is composed of the program counter PCₜ₋₁, the instruction memory 112, and two registers (FR1ₜ₋₁, FR2ₜ₋₁). A fetch unit of a third channel is composed of the program counter PCₜ₋₂, the instruction memory 112, and one register FR1ₜ₋₂.

The fetch circuit 110 includes two or more stages of fetch units. In FIG. 3, a fetch unit of a first stage (IF1) includes three registers (FR1ₜ, FR1ₜ₋₁, FR1ₜ₋₂). A fetch unit of a second stage (IF2) includes two registers (FR2ₜ, FR2ₜ₋₁). A register unit of a third stage (IF3) includes one register FR3ₜ.

The fetch circuit 110 further includes the comparison circuit 120.

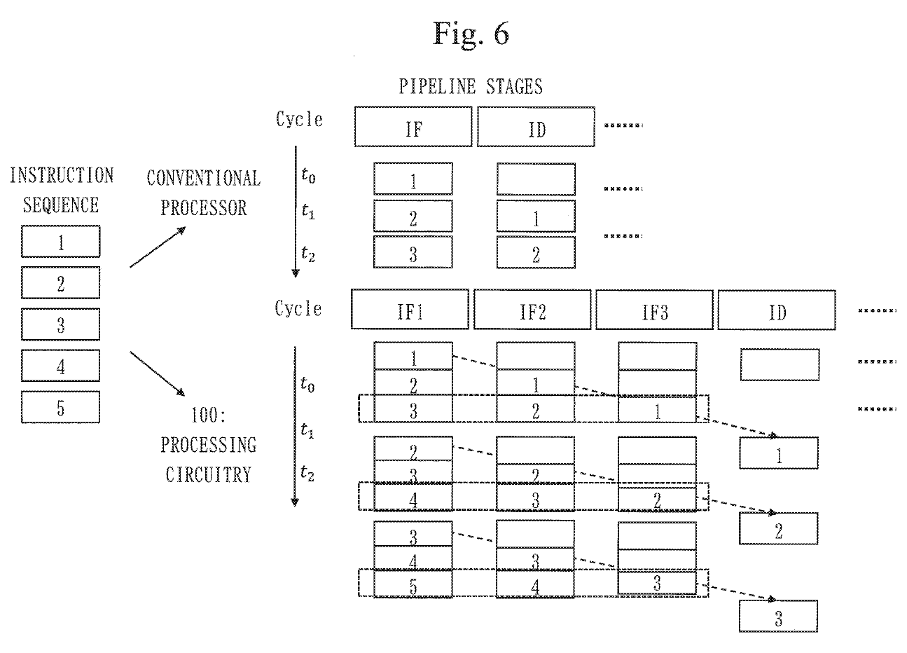

Based on FIG. 6, differences between the operation of the conventional processor and the operation of the processing circuitry 100 will be described.

The conventional processor decodes and executes an instruction fetched by the fetch circuit (IF) for each cycle time.

The processing circuitry 100 fetches, for each cycle time, two or more instructions in mutually different sequential positions using two or more channels of fetch units (IF1, IF2, IF3).

The processing circuitry 100 compares two or more instructions fetched by the two or more channels of fetch units at different cycle times (t₀, t₁, t₂), and decodes and executes an instruction selected based on majority vote, for each cycle time.

### Effects of Embodiment 1

Embodiment 1 discloses the processing circuitry 100 with fault tolerance.

The processing circuitry 100 can protect fetches by realizing redundancy of fetches.

The processing circuitry 100 fetches two or more mutually different instructions at the same time rather than simply realizing redundancy of fetches.

Therefore, it is difficult to cause an instruction skip in the processing circuitry 100 by targeting only one instruction, and there is a high probability that errors are also caused in other instructions that are fetched at the same time.

In the processing circuitry 100, fetch modules are pipelined rather than simply reused through time redundancy.

Therefore, in order to insert a fault once into the processing circuitry 100 to corrupt an instruction without the processing circuitry 100 noticing the fault, it is necessary to corrupt other instructions fetched at the same time in the same way.

However, it is generally difficult to insert faults consecutively with good control of timing and intensity so as to corrupt other instructions in the same way.

Even if other instructions can be corrupted in the same way, new instructions fetched with the other instructions at the same time are highly likely to be corrupted, so that the processing circuitry 100 can notice the fault.

Ultimately, in order to prevent a fault from being detected by the processing circuitry 100, it is necessary to continue to insert faults indefinitely and maintain consistency of instructions in the pipelined fetch modules. However, that is not realistic.

Therefore, the processing circuitry 100 can detect faults in fetches. That is, the processing circuitry 100 can protect fetches.

Furthermore, the processing circuitry 100 can notice faults targeted at stages other than fetches.

If a fault is inserted targeting at a stage other than fetches, a fetch that tends to be a critical path will also be corrupted.

Therefore, by monitoring fetches, it is possible to notice faults in stages other than fetches.

### Implementation Examples of Embodiment 1

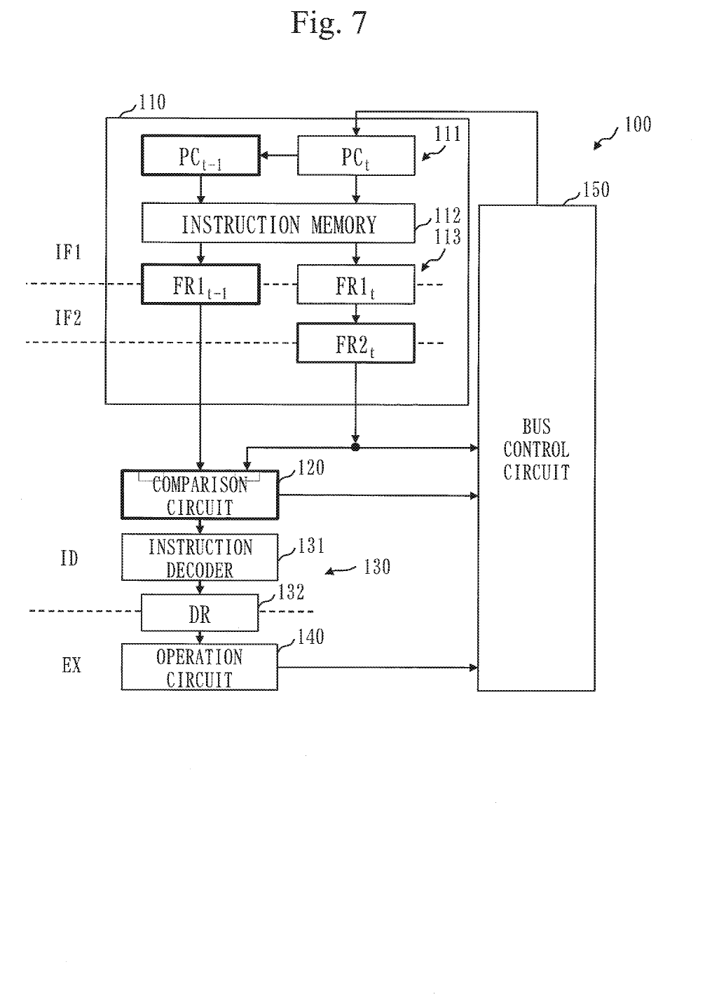

FIG. 7 illustrates an example of the configuration of the processing circuitry 100.

The fetch circuit 110 may include two channels and two stages of fetch units, as illustrated in FIG. 7.

In this case, if an instruction in the register FR2ₜ and an instruction in the register FR1ₜ₋₁ match, the instruction is executed.

If the instruction in the register FR2ₜ and the instruction in the register FR1ₜ₋₁ do no match, neither of the instructions is executed, and an alert signal is output.

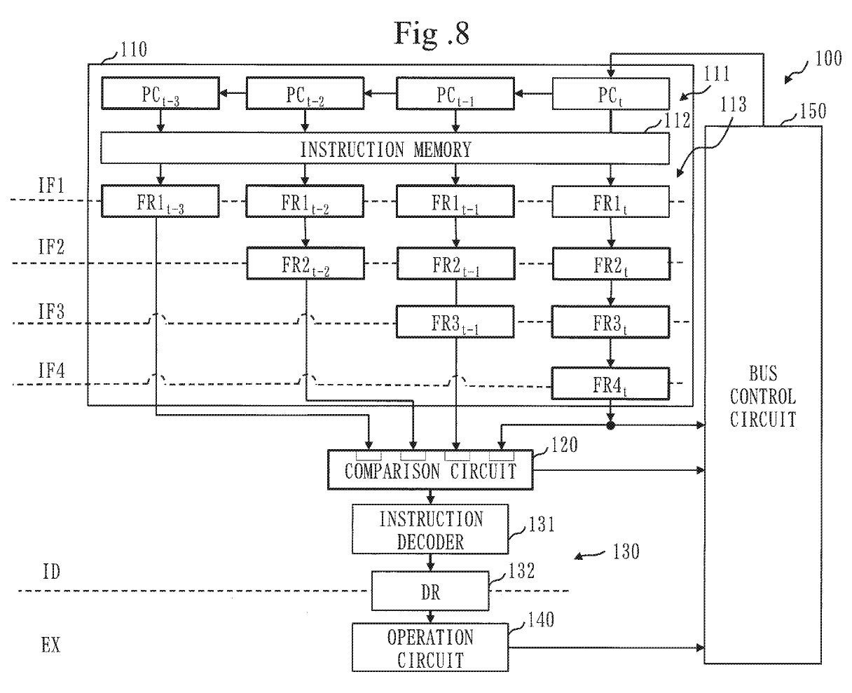

FIG. 8 illustrates an example of the configuration of the processing circuitry 100.

The fetch circuit 110 may include four or more channels and four or more stages of fetch units.

In FIG. 8, the fetch circuit 110 includes four channels and four stages of fetch units.

In this case, if an instruction in a register FR4ₜ, an instruction in a register FR3ₜ₋₁, an instruction in a register FR2ₜ₋₂, and an instruction in a register FR1ₜ₋₃ match, the instruction is executed.

If the instruction in the register FR4ₜ, the instruction in the register FR3ₜ₋₁, the instruction in the register FR2ₜ₋₂, and the instruction in the register FR1ₜ₋₃ do not match, an instruction is selected based on majority vote, and the selected instruction is executed. In addition, an alert signal is output.

If the instruction in the register FR4ₜ, the instruction in the register FR3ₜ₋₁, the instruction in the register FR2ₜ₋₂, and the instruction in the register FR1ₜ₋₃ are all different, none of the instructions is executed, and an alert signal is output.

When the fetch circuit 110 includes four or more channels of fetch units, the processing circuitry 100 may operate as described below.

The fetch circuit 110 fetches, for each cycle time, a reference instruction and also fetches three or more comparison instructions corresponding to three or more mutually different shift times.

The comparison circuit 120 randomly selects, for each cycle time, three instructions from three or more comparison instructions that are fetched and a reference instruction fetched at a cycle time that is earlier than each individual cycle time by the shift time corresponding to an individual comparison instruction of the three or more comparison instructions, where the individual cycle time is a cycle time at which the individual comparison instruction is fetched. Then, the comparison circuit 120 compares the three or more selected instructions.

If the three or more compared instructions match, the decode circuit 130 decodes the compared instruction, for each cycle time.

If the three or more compared instructions match, the operation circuit 140 executes the compared instruction (decoded instruction), for each cycle time.

If the three or more compared instructions do not match, the comparison circuit 120 selects an instruction to be executed based on majority vote among the three or more compared instructions, for each cycle time.

If the three or more compared instructions do not match, the decode circuit 130 decodes the instruction selected based on majority vote, for each cycle time.

If the three or more compared instructions do not match, the operation circuit 140 executes the instruction selected based on majority vote (decoded instruction), for each cycle time.

If the three or more compared instructions do not match, the comparison circuit 120 outputs an alert signal, for each cycle time.

When the fetch circuit 110 includes three or more channels of fetch units, the processing circuitry 100 may operate as described below.

The fetch circuit 110 fetches, for each cycle time, a reference instruction and also fetches two or more comparison instructions corresponding to two or more mutually different shift times.

The comparison circuit 120 randomly selects, for each cycle time, two instructions from two or more comparison instructions that are fetched and a reference instruction fetched at a cycle time that is earlier than each individual cycle time by the shift time corresponding to an individual comparison instruction of the two or more comparison instructions, where the individual cycle time is a cycle time at which the individual comparison instruction is fetched. Then, the comparison circuit 120 compares the two selected instructions.

If the two compared instructions match, the decode circuit 130 decodes the compared instruction, for each cycle time.

If the two compared instructions match, the operation circuit 140 executes the compared instruction (decoded instruction), for each cycle time.

If the two compared instructions do not match, the comparison circuit 120 outputs an alert signal.

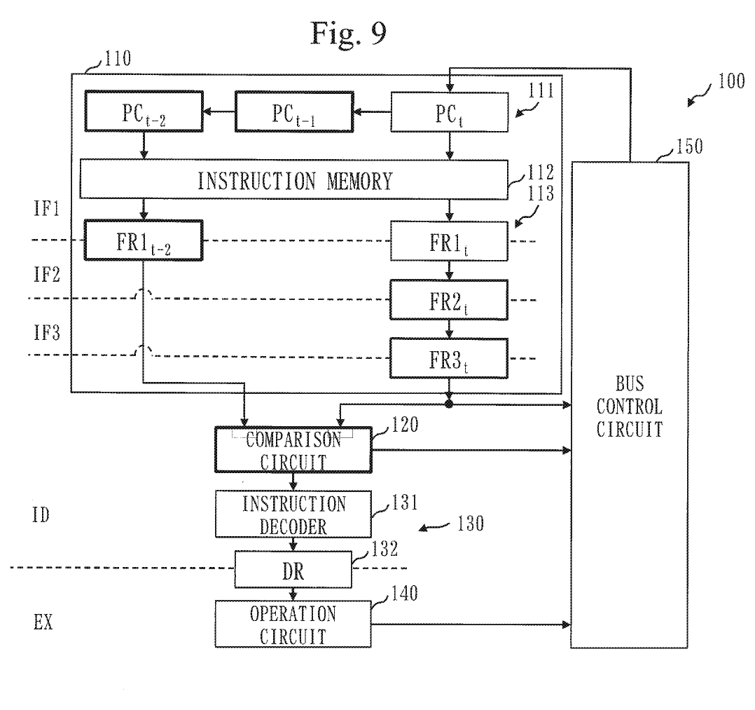

FIG. 9 illustrates an example of the configuration of the processing circuitry 100.

The shift time between channels may be a time period equivalent to two or more cycles instead of a time period equivalent to one cycle.

In FIG. 9, the fetch circuit 110 includes two channels of fetch units, and the shift time between channels is a time period equivalent to two cycles.

In this case, the fetch circuit 110 fetches, for each cycle time, a reference instruction of the cycle time to the register FR1ₜ.

At the same time, the fetch circuit 110 fetches a comparison instruction of a cycle time two cycles before the cycle time to the register FR1ₜ₋₂.

Even when the shift time between channels is a time period equivalent to two or more cycles, the fetch circuit 110 may include three channels of fetch units, or may include four or more channels of fetch units.

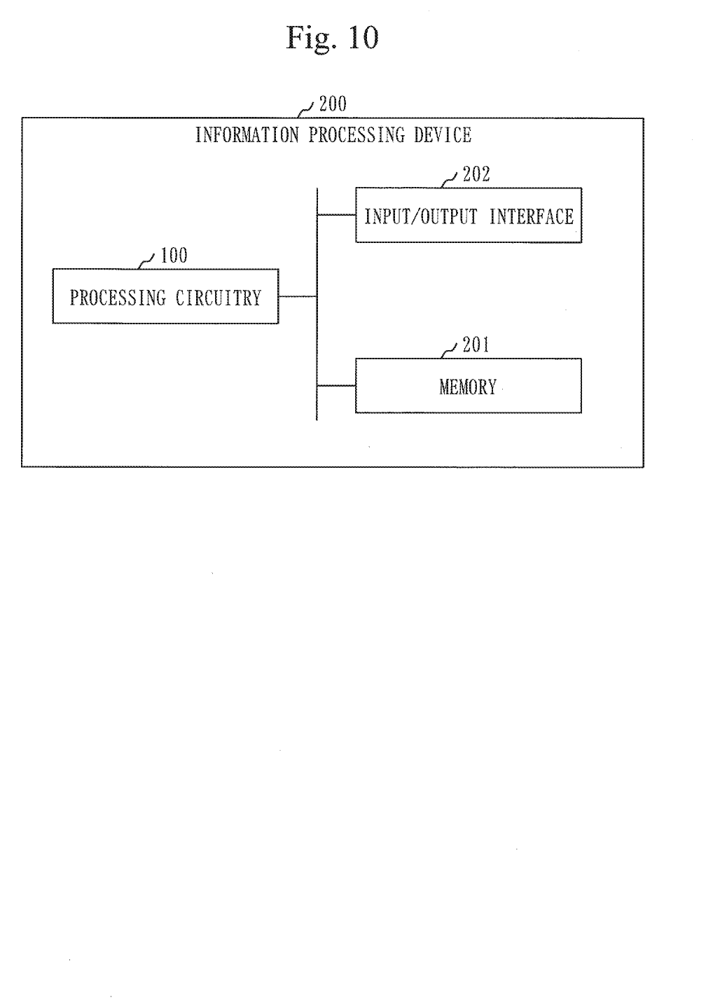

FIG. 10 illustrates an example of the configuration of an information processing device 200 on which the processing circuitry 100 is installed.

The processing circuitry 100 is installed and used mainly in the information processing device 200.

The information processing device 200 is a computer that includes hardware such as the processing circuitry 100, a memory 201, and an input/output interface 202.

### Supplement to Embodiment 1

Embodiment 1 is an example of a preferred embodiment, and is not intended to limit the technical scope of the present disclosure. Each embodiment may be partially implemented or implemented in combination with another embodiment.

### REFERENCE SIGNS LIST

100: processing circuitry; 110: fetch circuit; 111: program counter group; 112: instruction memory; 113: register group; 120: comparison circuit; 130: decode circuit; 131: instruction decoder; 132: register; 140: operation circuit; 150: bus control circuit; 200: information processing device; 201: memory; 202: input/output interface.

1. Processing circuitry comprising:
a fetch circuit to fetch, for each cycle time, an instruction of the cycle time as a reference instruction, and also fetch an instruction of a cycle time that is earlier than the cycle time by a shift time of one or more cycles as a comparison instruction;
a comparison circuit to compare, for each cycle time, a comparison instruction that is fetched with a reference instruction fetched at a cycle time that is earlier than a cycle time at which the comparison instruction is fetched by the shift time; and
an operation circuit to, when the compared reference instruction matches the compared comparison instruction, execute the compared reference instruction, for each cycle time.

2. The processing circuitry according to claim 1,
wherein when the compared reference instruction does not match the compared comparison instruction, the comparison circuit outputs an alert signal.

3. The processing circuitry according to claim 1,
wherein the fetch circuit fetches, for each cycle time, two or more comparison instructions corresponding to two or more mutually different shift times,
wherein the comparison circuit compares, for each cycle time, two or more comparison instructions that are fetched with a reference instruction fetched at a cycle time that is earlier than each individual cycle time by the shift time corresponding to an individual comparison instruction of the two or more comparison instructions, the individual cycle time being a cycle time at which the individual comparison instruction is fetched, and
wherein when the compared reference instruction matches the two or more compared comparison instructions, the operation circuit executes the compared reference instruction, for each cycle time.

4. The processing circuitry according to claim 3,
wherein when the compared reference instruction does not match at least one of the two or more compared comparison instructions, the operation circuit executes an instruction selected based on majority vote among the compared reference instruction and the two or more compared comparison instructions, for each cycle time.

5. The processing circuitry according to claim 3,
wherein when the compared reference instruction does not match at least one of the two or more compared comparison instructions, the comparison circuit outputs an alert signal, for each cycle time.

6. The processing circuitry according to claim 1,
wherein the fetch circuit fetches, for each cycle time, the reference instruction and also fetches two or more comparison instructions corresponding to two or more mutually different shift times,
wherein the comparison circuit randomly selects, for each cycle time, two instructions from two or more comparison instructions that are fetched and a reference instruction fetched at a cycle time that is earlier than each individual cycle time by the shift time corresponding to an individual comparison instruction of the two or more comparison instructions, the individual cycle time being a cycle time at which the individual comparison instruction is fetched, and compares two selected instructions, and
wherein when the two compared instructions match, the operation circuit executes the compared instruction, for each cycle time.

7. The processing circuitry according to claim 6,
wherein when the two compared instructions do not match, the comparison circuit outputs an alert signal, for each cycle time.

8. The processing circuitry according to claim 1,
wherein the fetch circuit fetches, for each cycle time, the reference instruction and also fetches three or more comparison instructions corresponding to three or more mutually different shift times,
wherein the comparison circuit randomly selects, for each cycle time, three or more instructions from three or more comparison instructions that are fetched and a reference instruction fetched at a cycle time that is earlier than each individual cycle time by the shift time corresponding to an individual comparison instruction of the three or more comparison instructions, the individual cycle time being a cycle time at which the individual comparison instruction is fetched, and compares three selected instructions, and
wherein when the three or more compared instructions match, the operation circuit executes the compared instruction, for each cycle time.

9. The processing circuitry according to claim 8,
wherein when the three or more compared instructions do not match, the operation circuit executes an instruction selected based on majority vote among the three or more compared instructions, for each cycle time.

10. The processing circuitry according to claim 8,
wherein when the three or more compared instructions do not match, the comparison circuit outputs an alert signal, for each cycle time.

11. The processing circuitry according to claim 1,
wherein the processing circuitry is one of a processor and an FPGA.

12. An information processing device comprising the processing circuitry according to claim 1.
